(19) United States
(12) Patent Application Publication
(10) Pub. No.: US 2014/0140107 A1
(43) Pub. Date: May 22, 2014

(54) ISOLATED POWER CONVERTER, INVERTING TYPE SHUNT REGULATOR, AND OPERATING METHOD THEREOF

(71) Applicant: Noveltek Semiconductor Corp., Zhubei City (TW)

(72) Inventors: Chern-Lin Chen, Zhubei City (TW); Chia-Jung Chang, Zhubei City (TW)

(73) Assignee: Noveltek Semiconductor Corp., Zhubei City (TW)

(21) Appl. No.: 14/074,934

(22) Filed: Nov. 8, 2013

(30) Foreign Application Priority Data
Nov. 16, 2012 (TW) 101142907

(51) Int. Cl. H02M 3/335

(52) U.S. Cl. CPC H02M 3/33523
USPC 363/21.15

(57) ABSTRACT

An isolated power converter, an inverting type shunt regulator, and an operating method thereof are disclosed. The isolated power converter includes a transformer, an inverting type shunt regulator, a controller, and an optocoupler. The inverting type shunt regulator is located on the secondary side of the transformer. The inverting type shunt regulator includes an error amplifier and a MOSFET. The controller is located on the primary side of the transformer. The controller includes an inverting unit cooperated with the MOSFET. The controller receives a feedback voltage. The optocoupler is coupled to the inverting type shunt regulator and the controller to provide an opto-coupling current to the controller.

### BACKGROUND OF THE INVENTION

1. Field of the Invention

The invention relates to an isolated power converter; in particular, to an isolated power converter with an inverting type shunt regulator and its operating method thereof

2. Description of the Prior Art

Please refer to FIG. 1. FIG. 1 illustrates a circuit diagram of a common feedback circuit structure applied in a flyback converter. As shown in FIG. 1, in the common feedback circuit structure applied in the flyback converter 1, a three-terminal adjustable shunt regulator 10 having good heat stability is used as an error-amplifying device.

When the flyback converter 1 is operated at a stable state, if the output load of the flyback converter 1 becomes larger, the feedback voltage V_{FB} will have a higher level. The switch-driving signal V_{G} can have a longer duty cycle through a pulse-width modulator PWM shown in FIG. 2. On the contrary, when the output load of the flyback converter 1 becomes smaller or even no zero, the feedback voltage V_{FB} will have a lower level. This will increase the current I_{LED} flowing through the light-emitting diode OC1 of the optocoupler and the current I_{FB} flowing through the phototransistor OC2 of the optocoupler and cause more energy consumption.

When the feedback voltage V_{FB} is smaller than the threshold voltage V_{L}, the pulse-width modulator PWM will stop outputting the driving signal, and it will output the driving signal again until the feedback voltage V_{FB} comes back to the threshold voltage V_{H}. Please refer to FIG. 3. FIG. 3 shows the relationship of the feedback voltage V_{FB}, the current I_{LED} flowing through the light-emitting diode OC1, and the current I_{FB} flowing through the phototransistor OC2 versus the output power of the flyback converter 1 when the flyback converter 1 is operated at a stable state. When the output power is smaller than the threshold power P_{TH}, the balancing way of the feedback voltage V_{FB} is to swing between the threshold voltages V_{H} and V_{L}, as shown in FIG. 4. FIG. 4 also shows the mode of the switch-driving signal V_{G} under this condition.

However, because the current I_{LED} flowing through the light-emitting diode OC1 of the optocoupler and the current I_{FB} flowing through the phototransistor OC2 of the optocoupler are increased when the conventional flyback converter 1 is operated at a light-load state, the energy consumption will be increased. As a result, the standby power consumption of the isolated power converter will be large and the light-load efficiency of the isolated power converter will be poor, making the feedback circuit shown in FIG. 1 undesirable from an energy saving point of view.

Therefore, the invention provides an isolated power converter with an inverting type shunt regulator and its operating method thereof to solve the above-mentioned problems occurred in the prior arts.

### SUMMARY OF THE INVENTION

A scope of the invention is to provide an isolated power converter. In a preferred embodiment, the isolated power converter includes a transformer, an inverting type shunt regulator, a controller, and an optocoupler. The inverting type shunt regulator is located on the secondary side of the transformer. The inverting type shunt regulator includes an error amplifier and a MOSFET. The controller is located on the primary side of the transformer. The controller includes an inverting unit cooperated with the MOSFET. The controller receives a feedback voltage. The optocoupler is coupled to the inverting type shunt regulator and the controller to provide an opto-coupling current to the controller.

In an embodiment, the MOSFET is a p-type MOSFET or an n-type MOSFET.

In an embodiment, the controller further includes a pulse-width modulator. If the feedback voltage received by the controller is a positive-phase feedback voltage, the inverting unit will convert the positive-phase feedback voltage into an inverting feedback voltage and the pulse-width modulator will generate a switch-driving signal according to the inverting feedback voltage.

In an embodiment, the controller further includes an inverting-type pulse-width modulator. If the feedback voltage received by the controller is a positive-phase feedback voltage, the inverting-type pulse-width modulator will convert the positive-phase feedback voltage into an inverting feedback voltage and generate a switch-driving signal according to the inverting feedback voltage.

In an embodiment, the controller further includes a pulse-width modulator. If the feedback voltage received by the controller is an inverting feedback voltage, the pulse-width modulator will generate a switch-driving signal according to the inverting feedback voltage.

In an embodiment, the inverting type shunt regulator further includes a first terminal, a second terminal, a third terminal, and a fourth terminal. The first terminal is coupled to an external reference voltage. The third terminal is coupled to the optocoupler. The fourth terminal is coupled to a ground terminal. A compensating circuit is coupled between the first terminal and the third terminal The MOSFET is coupled between the second terminal and the third terminal.

In an embodiment, the inverting type shunt regulator further includes a first terminal, a second terminal, a third terminal, and a fourth terminal. The first terminal is coupled to an external reference voltage. The third terminal is coupled to the optocoupler. The third terminal is coupled to a ground terminal The fourth terminal is coupled between the error amplifier and the MOSFET. One terminal of a compensating circuit is coupled to the first terminal, and the other terminal of the compensating circuit is coupled to the fourth terminal The MOSFET is coupled between the second terminal and the third terminal.

In an embodiment, the controller is a pulse-width modulation controller. The optocoupler is coupled to the pulse-width modulation controller and a ground terminal The optocoupler provides a positive-phase feedback voltage to the pulse-width modulation controller.

In an embodiment, the controller is a pulse-width modulation controller. The pulse-width modulation controller is coupled to a supply voltage. The optocoupler is coupled to the supply voltage and the pulse-width modulation controller. The optocoupler provides an inverting feedback voltage to the pulse-width modulation controller.

Another scope of the invention is to provide an inverting type shunt regulator. In a preferred embodiment, the inverting type shunt regulator is applied in an isolated power converter including a transformer and a controller. The controller is located on the primary side of the transformer and includes an inverting unit. The inverting type shunt regulator is located on the secondary side of the transformer and cooperates with the inverting unit. The inverting type shunt regulator includes a first terminal, a second terminal, a third terminal, an error amplifier, and a MOSFET. The first terminal is coupled to an external reference voltage. The error amplifier has a first input terminal, a second input terminal, and an output terminal. The first input terminal is coupled to the first terminal and the second input terminal is coupled to an internal reference voltage. The MOSFET is coupled between the second terminal and the third terminal The gate electrode of the MOSFET is coupled to the output terminal of the error amplifier.

Another scope of the invention is to provide an operating method of an isolated power converter. In a preferred embodiment, the isolated power converter includes a transformer, an inverting type shunt regulator, a controller, and an optocoupler. The controller is located on the primary side of the transformer and includes an inverting unit. The inverting type shunt regulator is located on the secondary side of the transformer and includes an error amplifier and a MOSFET. The inverting unit cooperates with the MOSFET.

The operating method includes following steps of: using the inverting type shunt regulator to control an opto-coupling current provided for the controller by the optocoupler; using the controller to receive a feedback voltage which is determined according to the opto-coupling current and generate a switch-driving signal according to the feedback voltage; decreasing the opto-coupling currents and increasing the feedback voltage when the output power of the isolated power converter becomes smaller; and using the controller to reduce the duty cycle of the switch-driving signal according to the feedback voltage having a higher level.

Compared with the prior arts, when the output power of the isolated power converter becomes smaller, the invention can lower down the currents flowing through the optocoupler to reduce its energy consumption. In addition, because the energy consumption is reduced, the total energy that the isolated power converter should provide is also reduced. And in the meantime, the operating consumption of the isolated power converter, such as switching loss, conduction loss, and transformer loss, can all be reduced as well. Therefore, the invention can enhance the light-load efficiency of the isolated power converter and reduce the standby power consumption of the isolated power converter.

The advantage and spirit of the invention may be understood by the following detailed descriptions together with the appended drawings.

### BRIEF DESCRIPTION OF THE APPENDED DRAWINGS

FIG. 1 illustrates a circuit diagram of a common feedback circuit structure applied in a flyback converter.

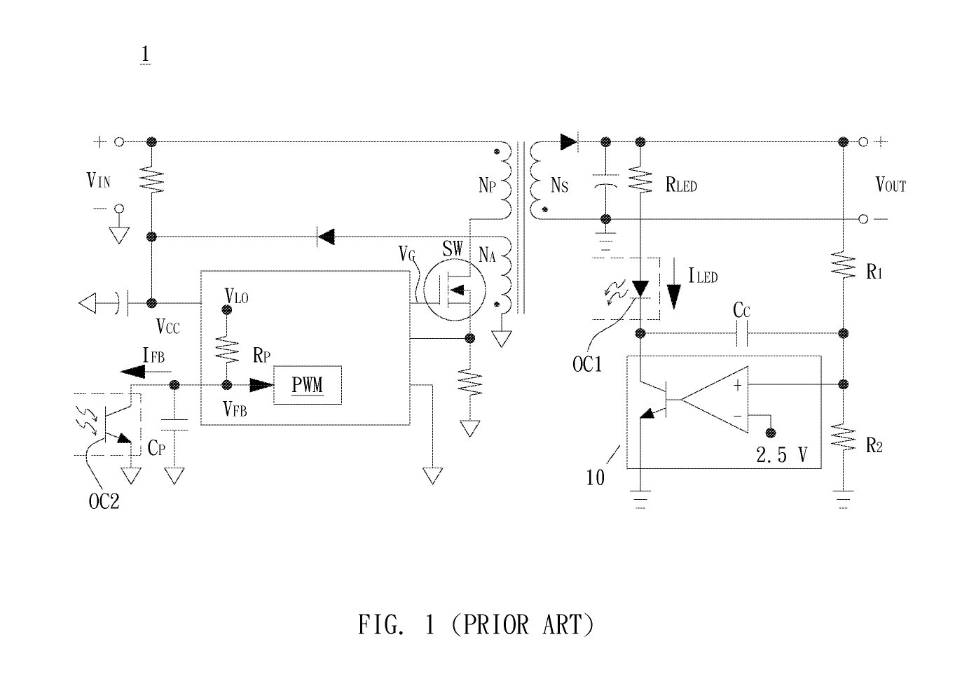

FIG. 2 illustrates a circuit diagram of the pulse-width modulator shown in FIG. 1.

FIG. 3 illustrates the relationship of the feedback voltages and the currents flowing through the optocoupler versus the output power of the flyback converter when the flyback converter is operated at a stable state.

FIG. 4 illustrates the waveforms of the feedback voltage and the switch-driving signal when the flyback converter is operated at a very light-load state or the no-load state.

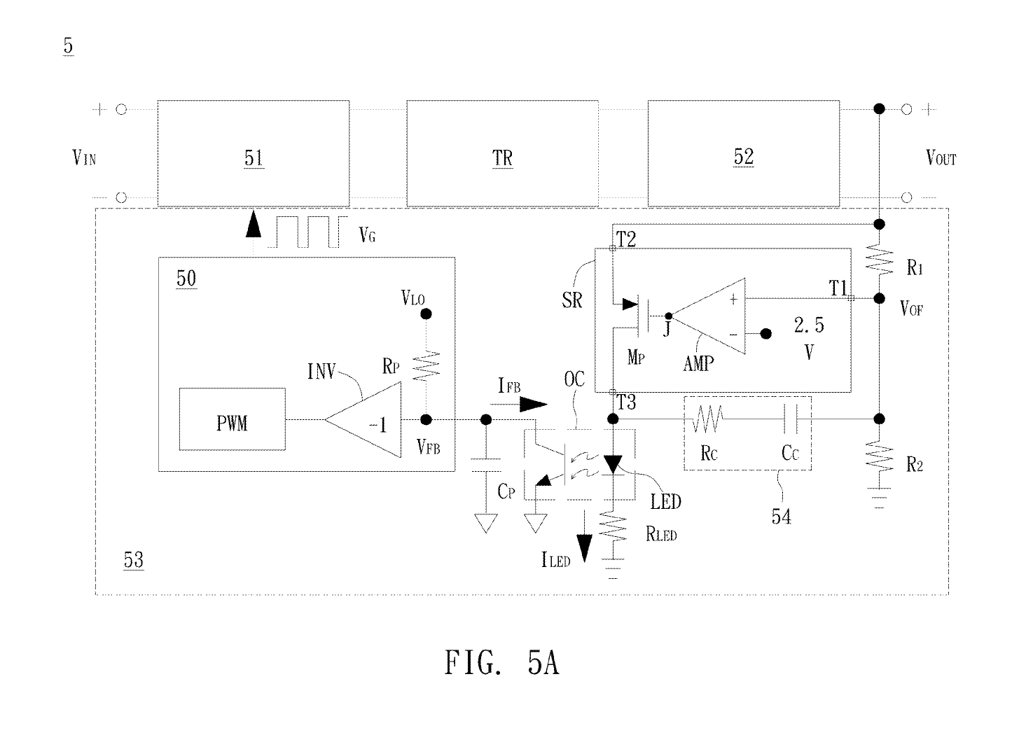

FIG. 5A illustrates a circuit diagram of a preferred embodiment of the isolated power converter according to the present invention.

FIG. 5B illustrates an embodiment of the isolated power converter shown in FIG. 5A.

FIG. 6 illustrates the relationship of the feedback voltage and the opto-coupling currents flowing through the optocoupler versus the output power of the isolated power converter shown in FIG. 5A.

FIG. 7 illustrates a circuit diagram of another embodiment of the isolated power converter according the present invention.

FIG. 8 illustrates a circuit diagram of the inverting type pulse-width modulator shown in FIG. 7.

FIG. 9 illustrates a circuit diagram of another embodiment of the isolated power converter according the present invention

FIG. 10 and FIG. 11 illustrate circuit diagrams of another two embodiments of the isolated power converter according the present invention.

FIG. 12 illustrates a circuit diagram of another embodiment of the isolated power converter according the present invention.

FIG. 13 illustrates a circuit diagram of another embodiment of the isolated power converter according the present invention.

FIG. 14 illustrates a flow chart of the operating method of the isolated power converter according to the present invention.

### DETAILED DESCRIPTION OF THE INVENTION

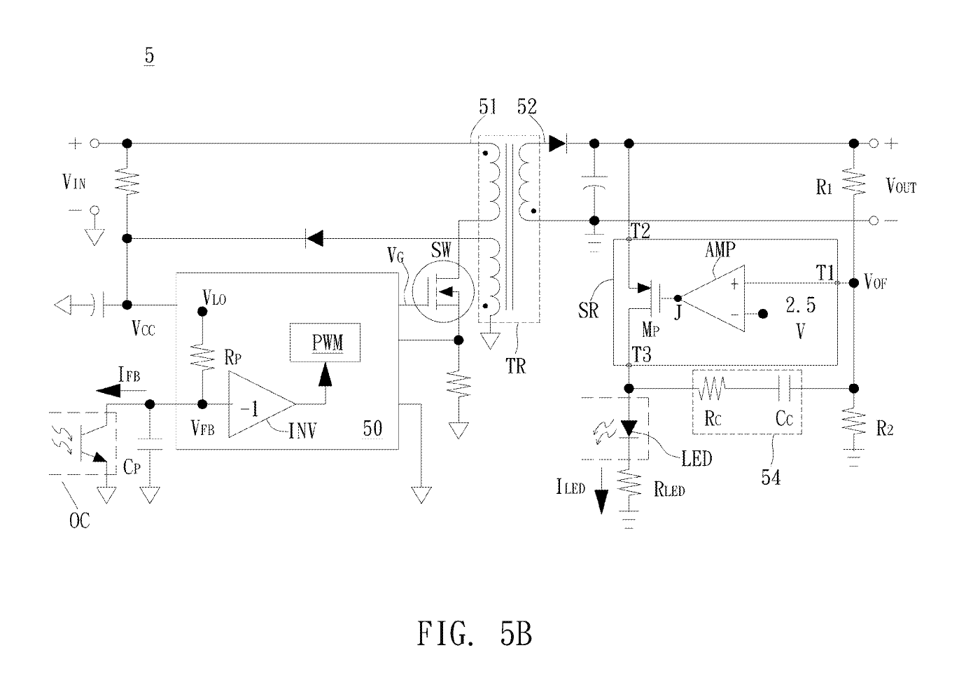

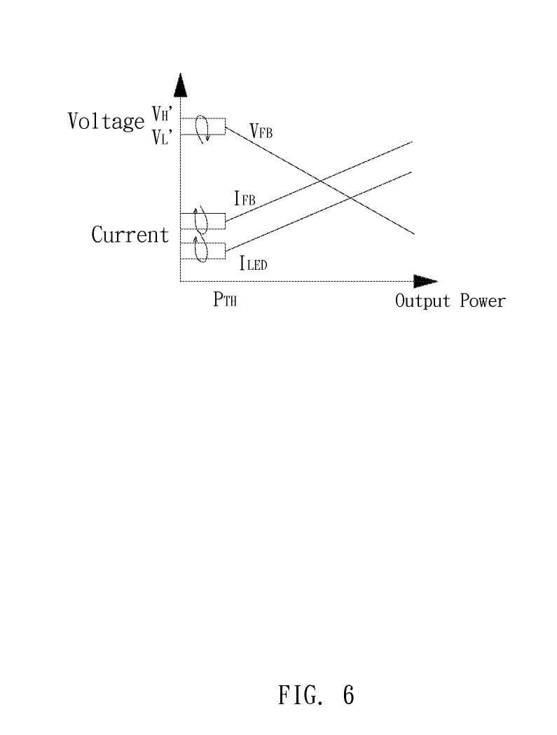

A preferred embodiment of the invention is an isolated power converter. In fact, the isolated power converter in this embodiment can be, but not limited to, a flyback converter having an isolated transformer. Please refer to FIG. 5A. FIG. 5A illustrates a circuit diagram of a preferred embodiment of the isolated power converter according to the present invention. As shown in FIG. 5A, the isolated power converter 5 includes a primary-side power stage 51, an isolated transformer TR, a secondary-side power stage 52, and a feedback circuit 53. The feedback circuit 53 is implemented with various circuit structures provided by the embodiments of the invention.

In the embodiment shown in FIG. 5A, the feedback circuit 53 includes a controller 50, an inverting type shunt regulator SR, an optocoupler OC, and a compensating circuit 54. The inverting type shunt regulator SR is used as an error amplifying device in the isolated power converter 5 to replace the conventional three-terminal adjustable shunt regulator. In general, a three-terminal shunt regulator is a low-cost semiconductor device. Except for being used to implement a simple shunt regulator, it can be also used as a low-cost operational amplifier in the control loops of power supplies.

It should be mentioned that the inverting type shunt regulator is formed by an error amplifier, a reference voltage generator, and a MOSFET. The output terminal of the error amplifier is coupled to the gate electrode of the MOSFET. If the MOSFET used in the inverting type shunt regulator is a p-type MOSFET, the internal reference voltage is connected to the inverting input terminal of the error amplifier; if the MOSFET used in the inverting type shunt regulator is a n-type MOSFET, the internal reference voltage is connected to the non-inverting input terminal of the error amplifier.

As shown in FIG. 5A and FIG. 5B, the inverting type shunt regulator SR includes a first terminal T1, a second terminal T2, a third terminal T3, an error amplifier AMP, and a p-type MOSFET M_{P}. The error amplifier AMP includes a first input terminal (non-inverting input terminal)+, a second input terminal (inverting input terminal)−, and an output terminal J.

The first input terminal+is coupled to the first terminal T1, and the second input terminal−is coupled to the internal reference voltage (2.5 V in this embodiment). The p-type MOSFET Mp is coupled between the second terminal T2 and the third terminal T3, and the gate electrode of the p-type MOSFET Mp is coupled to the output terminal J of the error amplifier AMP. In this embodiment, the first terminal T1 of the inverting type shunt regulator SR is coupled to an external reference voltage V_{OF}. The second terminal T2 is coupled to an output voltage V_{OUT} of the isolated power converter 5, the third terminal T3 is coupled to a light-emitting diode LED and a compensating resistor R_{C}. The compensating circuit 54 includes the compensating resistor R_{C} and a compensating capacitor C_{C} which are coupled in series, and the compensating circuit 54 is coupled between the first terminal T1 and the third terminal T3 of the inverting type shunt regulator SR.

When the output voltage V_{OUT} of the isolated power converter 5 is increased, the inverting type shunt regulator SR will lower down the conduction current of the p-type MOSFET M_{P} to make I_{LED} flowing through the light-emitting diode LED become smaller. On the contrary, when the output voltage V_{OUT} of the isolated power converter 5 is decreased, the inverting type shunt regulator SR will increase the conduction current of the p-type MOSFET M_{P} to make I_{LED} flowing through the light-emitting diode LED become larger.

Because the inverting type shunt regulator SR and the light-emitting diode LED are located on the secondary side of the isolated transformer TR, the LED current I_{LED} is a secondary-side current. A primary-side opto-coupling current induced by the optocoupler OC on the primary side of the isolated transformer TR is a feedback current I_{FB}, and a feedback voltage V_{FB} will be determined by the feedback current I_{FB}. After the feedback voltage V_{FB} is processed by an inverting amplifier INV of the controller 50, it will be sent to the pulse-width modulator PWM to determine the duty cycle of a switch-driving signal V_{G} which is output to a switch SW.

Therefore, when the isolated power converter 5 is operated at a stable state, the feedback voltage V_{FB} will have a lower level if the isolated power converter 5 has a heavier load. Then, after the feedback voltage V_{FB} is processed by the inverting amplifier INV, the switch-driving signal V_{G} determined by the pulse-width modulator PWM will have a longer duty cycle. On the contrary, if the isolated power converter 5 has a lighter load or even no load, the feedback voltage V_{FB} will have a higher level. Then, after the feedback voltage V_{FB} is processed by the inverting amplifier INV, the switch-driving signal V_{G} determined by the pulse-width modulator PWM will have a shorter duty cycle. This will make the LED current I_{LED} and the feedback current I_{FB} have less energy consumption under a lighter-load or the no-load condition.

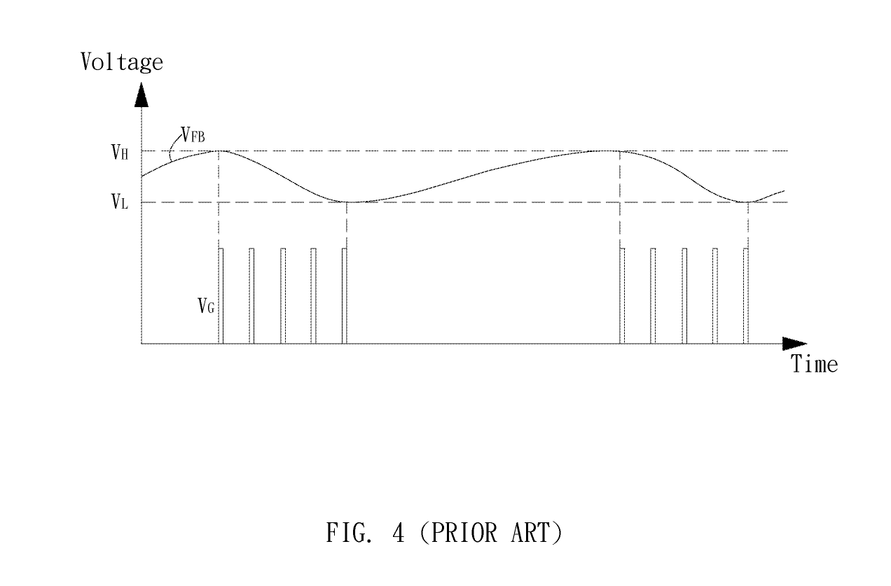

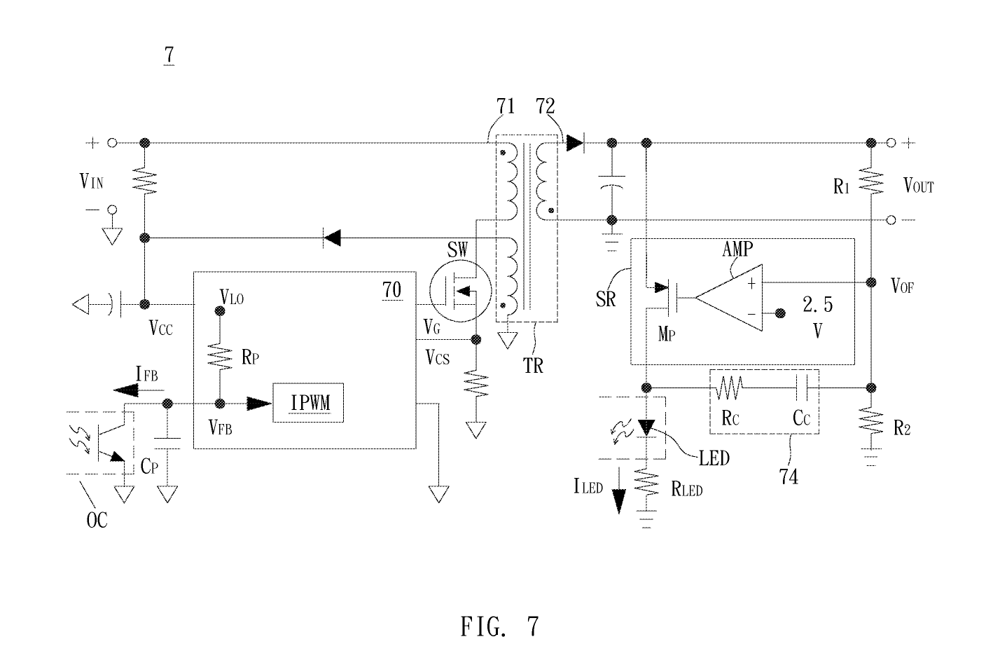

FIG. 6 illustrates the relationship of the feedback voltage V_{FB} and the opto-coupling currents (I_{FB} and I_{LED}) versus the output power of the isolated power converter 5. Comparing FIG. 6 with FIG. 3 (prior art), it can be found that the variation trend of the feedback voltage V_{FB} and the opto-coupling currents (I_{FB} and I_{LED}) versus the output power of the isolated power converter 5 shown in FIG. 6 is reverse to that shown in FIG. 3 (prior art). That is to say, when the output power of the isolated power converter 5 becomes smaller or even no load, the feedback voltage V_{FB} will have a higher level and the opto-coupling currents (I_{FB} and I_{LED}) will become smaller; therefore, the power consumption of the isolated power converter 5 at a light-load state can be effectively lowered down to improve the light-load efficiency.

In addition, when the load of the isolated power converter 5 is smaller than a threshold power P_{TH}, the feedback voltage V_{FB} will swing between two threshold voltages V_{H}′ and V_{L}′. However, the two threshold voltages V_{H}′ and V_{L}′ in FIG. 6 are obviously higher than the two threshold voltages V_{H} and V_{L} in FIG. 3 (prior art), and therefore the opto-coupling currents (I_{FB} and I_{LED}) can have lower current values to reduce the power consumption of the isolated power converter 5 at a light-load state.

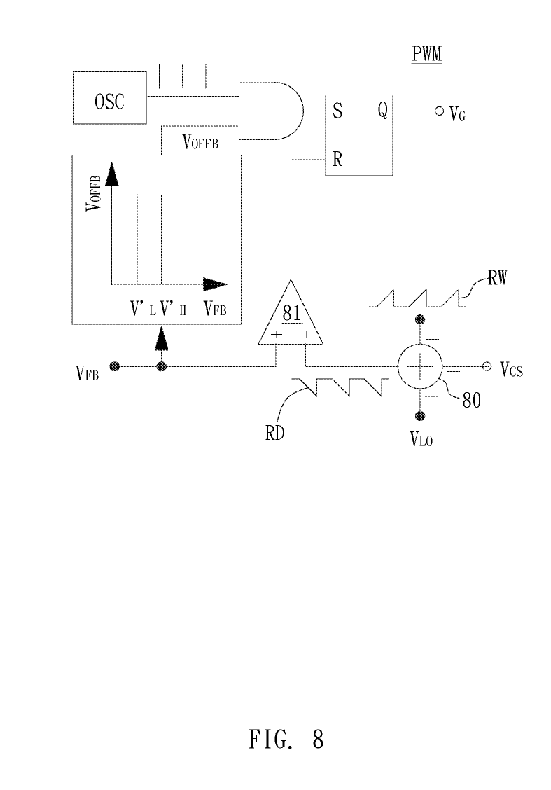

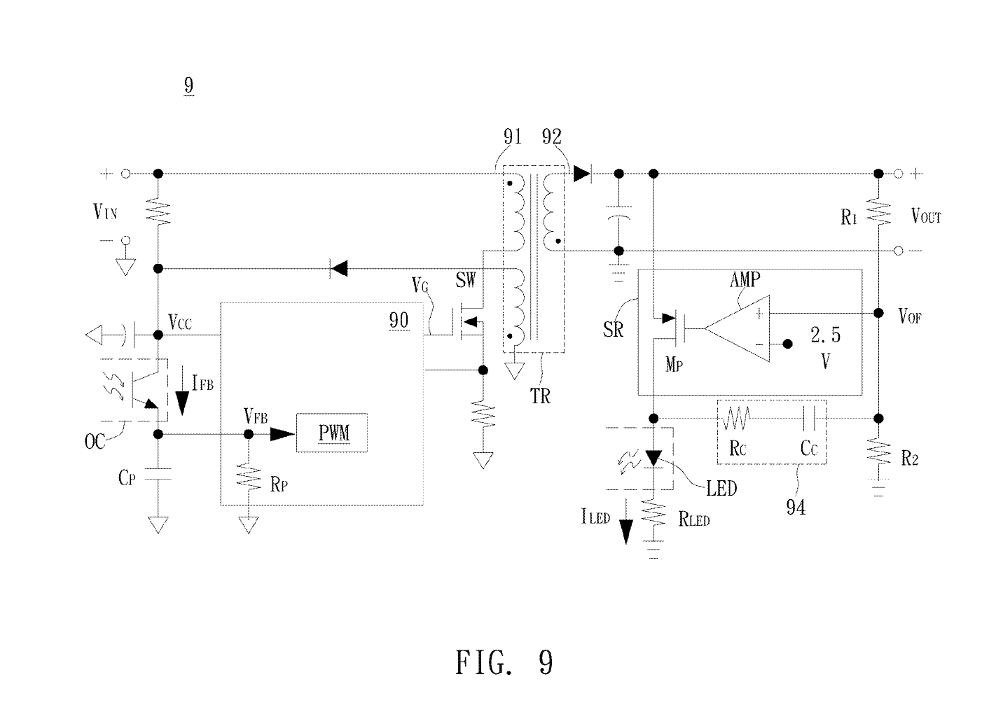

Please refer to FIG. 7. FIG. 7 illustrates a circuit diagram of another embodiment of the isolated power converter according to the present invention. As shown in FIG. 7, when the controller 70 located on the primary side of the isolated power converter 7 receives the feedback voltage V_{FB}, an inverting-type pulse-width modulator IPWM instead of an inverting amplifier INV in the controller 50 shown in FIG. 5 is adopted to directly perform the inverting process on the feedback voltage V_{FB} and subsequently generate a switch-driving signal V_{G}. FIG. 8 illustrates a schematic diagram of the inverting-type pulse-width modulator IPWM shown in FIG. 7.

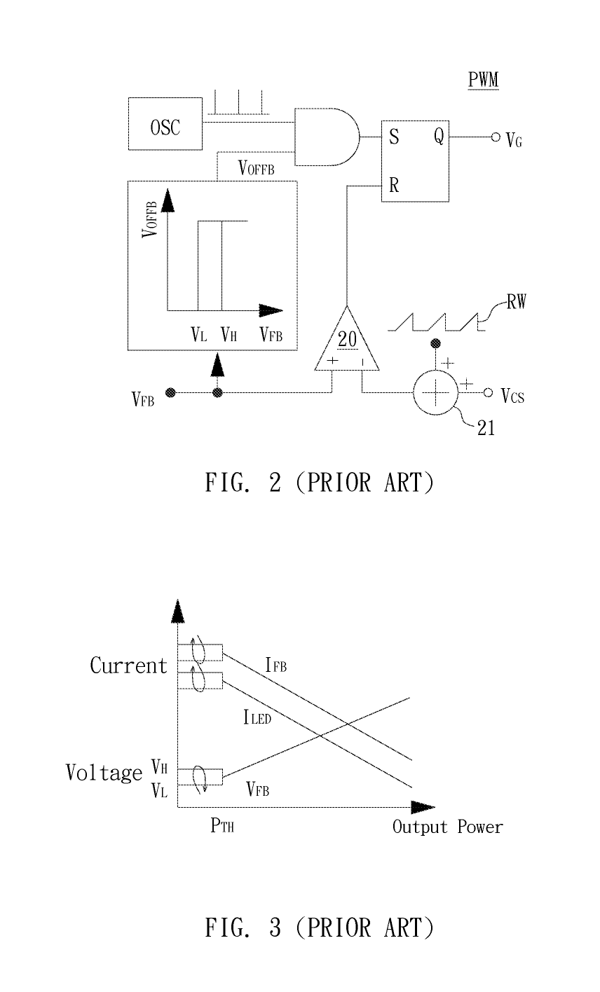

Different from that shown in FIG. 2, in FIG. 8, the adder adds the sensed inductor current signal V_{CS} to a sawtooth signal RW for the slope compensation and then substrates them by a DC voltage to obtain an inverting-type superimposed signal RD. Then, the comparator 81 will compare the inverting-type superimposed signal RD with the feedback voltage V_{FB} to determine the pulse width (duty cycle) of the switch-driving signal V_{G}. An equivalent result to the above-mentioned procedure will be obtained by letting the feedback voltage V_{FB} be first processed by the inverting amplifier INV and then compared with the superimposed signal originated from the sensed inductor current signal V_{CS} and a sawtooth signal RW to determine the pulse width (duty cycle) of the switch-driving signal V_{G}.

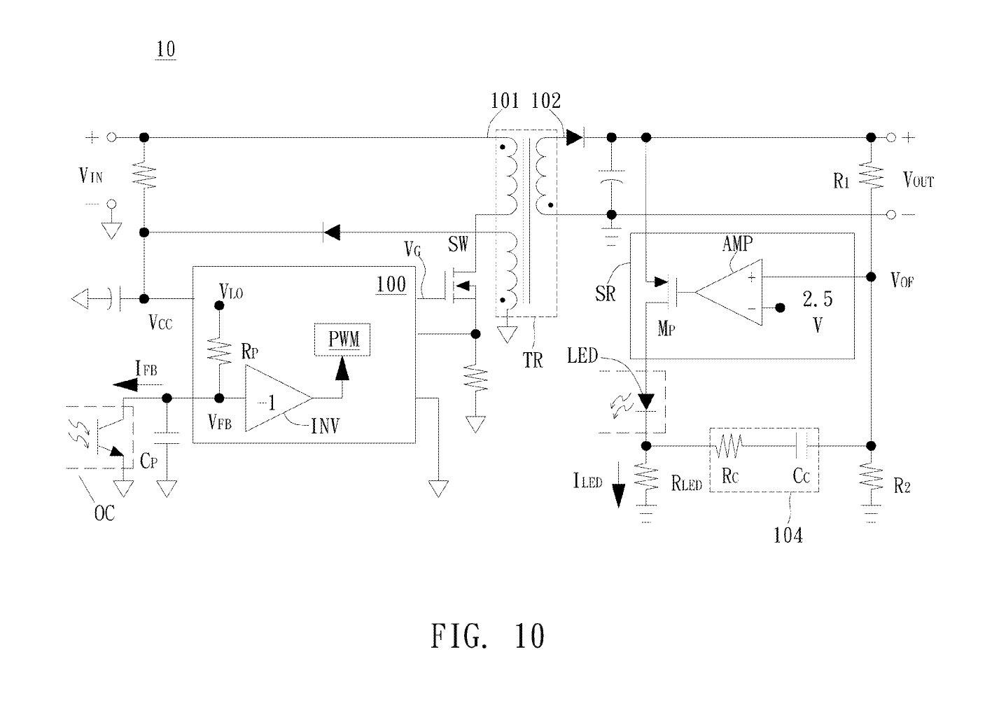

Please refer to FIG. 9. FIG. 9 illustrates a circuit diagram of another embodiment of the isolated power converter according to the present the invention. As shown in FIG. 9, the collector of the phototransistor in the optocoupler OC is coupled to the supply voltage V_{CC} of the pulse-width modulation controller 90 and the emitter of the phototransistor is coupled to the resistor R_{P} in the pulse-width modulation controller 90. Compared to the feedback voltage V_{FB} shown in FIG. 5, the feedback voltage V_{FB} shown in FIG. 9 has a reverse phase; therefore, it is unnecessary to place an inverting amplifier in the controller 90 to reverse the phase of the feedback voltage V_{FB}. The pulse-width modulator PWM can directly generate a switch-driving signal V_{G} according to the feedback voltage V_{FB} having a reverse phase.

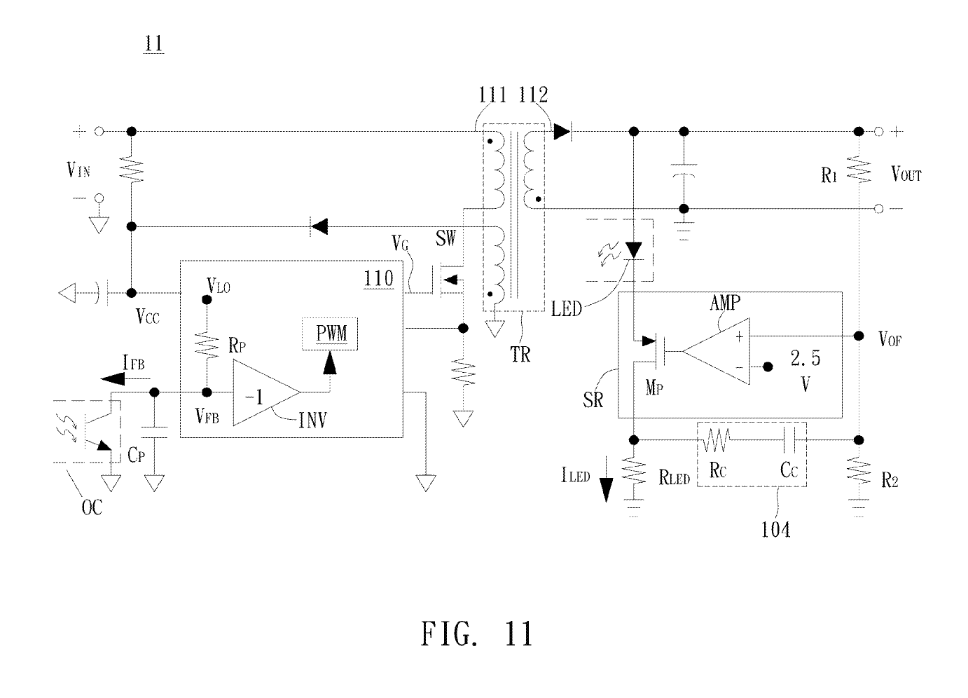

Please refer to FIG. 10 and FIG. 11. FIG. 10 and FIG. 11 illustrate circuit diagrams of another two embodiments of the isolated power converter according to the present invention. As shown in FIG. 10, the resistor R_{C} and a capacitor C_{C} are coupled in series (namely the compensating circuit) on the secondary side of the isolated power converter 10. One terminal of the compensating circuit is coupled between the light-emitting diode LED and R_{LED}. As shown in FIG. 11, instead of being coupled between the inverting type shunt regulator SR and R_{LED} shown in FIG. 5, FIG. 7, FIG. 9, and FIG. 10, the light-emitting diode LED located on the secondary side of the isolated power converter 11 is coupled between the inverting type shunt regulator SR and the output voltage of the isolated power converter.

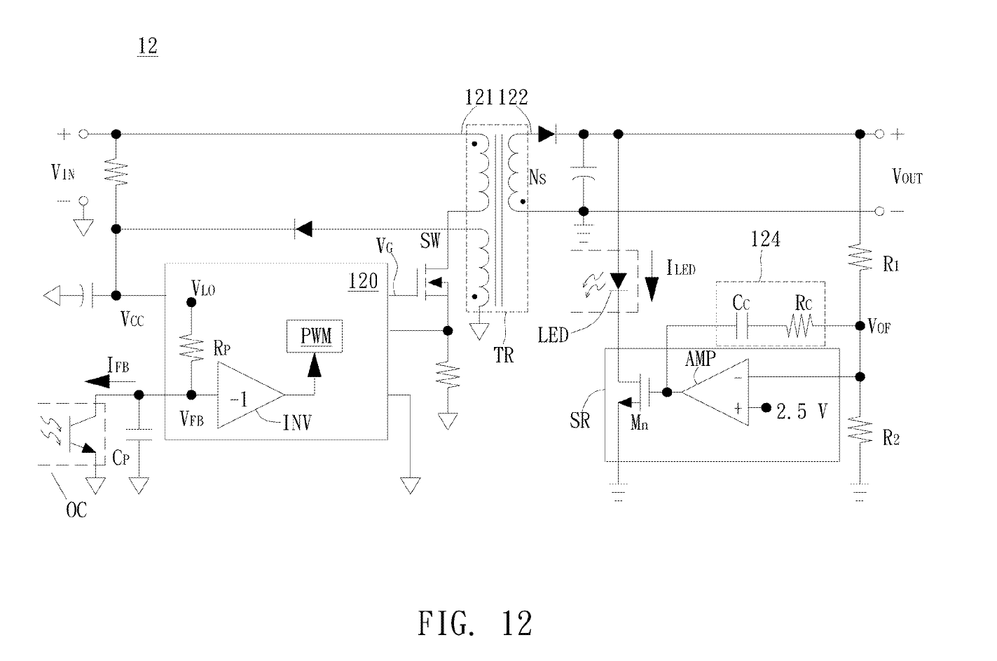

FIG. 12 illustrates a circuit diagram of another embodiment of the isolated power converter according to the present invention. As shown in FIG. 12, an n-type MOSFET Mₙ is used in the inverting type shunt regulator SR located on the secondary side of the isolated power converter 12, and an internal reference voltage (2.5 V) is connected to the non-inverting input terminal+of the error amplifier AMP. Therefore, the output of the inverting type shunt regulator SR is changed to pull down a current by the n-type MOSFET Mₙ, and the compensating method is to couple the output terminal of the error amplifier AMP to the divided output voltage V_{OF} through the compensating circuit (namely the resistor R_{C} and the capacitor C_{C} which are coupled in series). It should be noticed that it is unnecessary to place R_{LED} in this circuit structure.

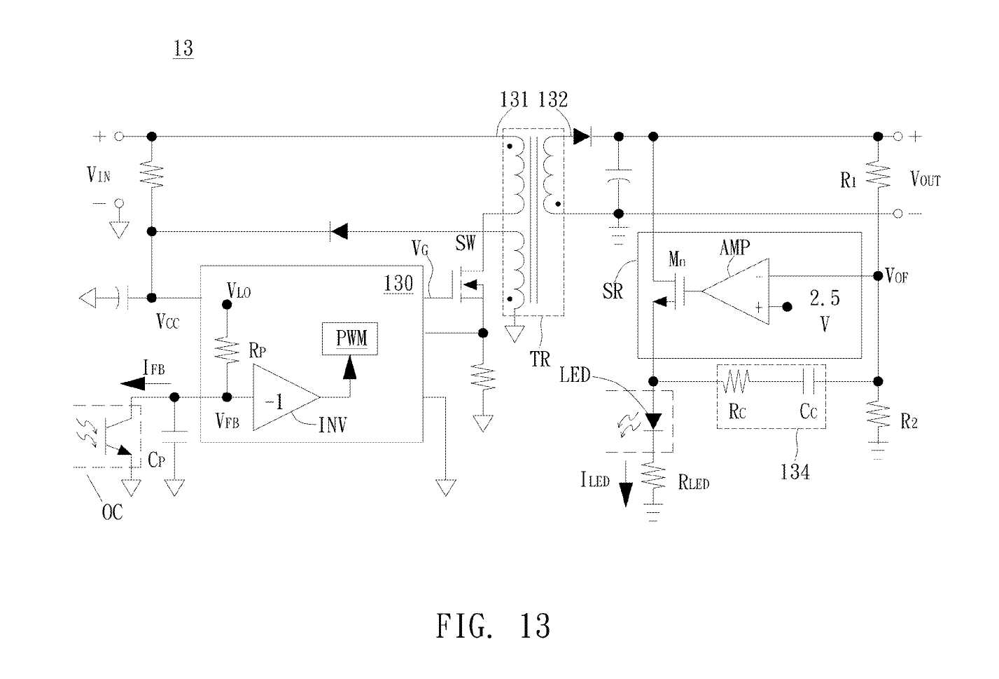

FIG. 13 illustrates a circuit diagram of another embodiment of the isolated power converter according to the present invention. As shown in FIG. 13, an n-type MOSFET Mₙ is used in the inverting type shunt regulator SR located on the secondary side of the isolated power converter 13, and the n-type MOSFET Mₙ is used as a source follower at this time. Therefore, the compensating method is to couple the source electrode of the n-type MOSFET Mₙ to the divided output voltage V_{OF} through the compensating circuit (namely the resistor R_{C} and the capacitor C_{C} which are coupled in series).

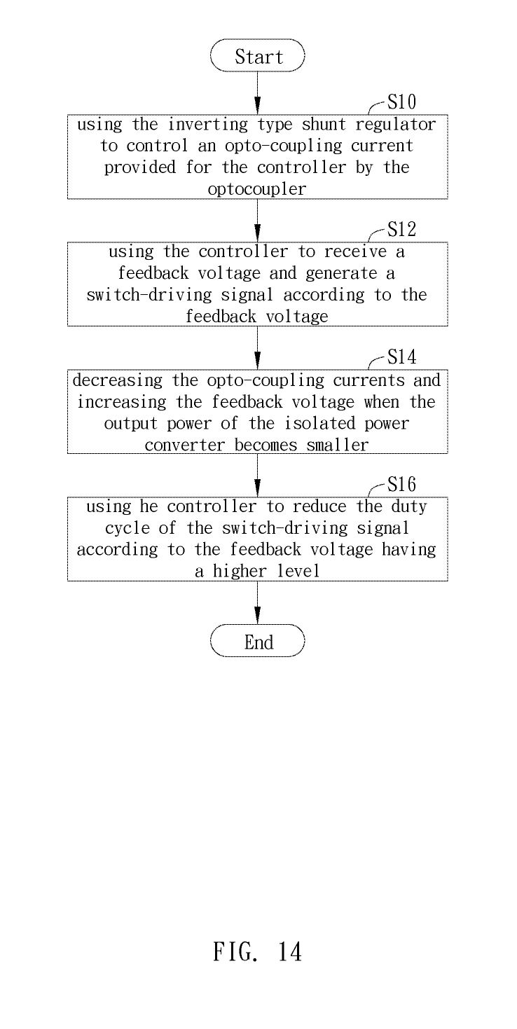

Another preferred embodiment according to the present invention is an operating method for an isolated power converter. In this preferred embodiment, the isolated power converter includes a transformer, an inverting type shunt regulator, a controller, and an optocoupler. The controller is located on the primary side of the transformer and includes an inverting unit. The inverting type shunt regulator is located on the secondary side of the transformer and includes an error amplifier and a MOSFET. The inverting unit is cooperated with the MOSFET. The light-emitting diode (LED) of the optocoupler is coupled between the inverting type shunt regulator and a resistor, and the resistor is coupled to the ground terminal The LED can also be coupled between the output voltage of the isolated power converter and the inverting type shunt regulator. Please refer to FIG. 14. FIG. 14 illustrates a flow chart of the operating method of the isolated power converter according to the present invention.

As shown in FIG. 14, the step S10 is to use the inverting type shunt regulator to control an opto-coupling current provided for the controller by the optocoupler. The step S12 is to use the controller to receive a feedback voltage which is determined according to the opto-coupling current and generate a switch-driving signal according to the feedback voltage. In fact, the feedback voltage received by the controller can be a positive-phase feedback voltage or an inverting feedback voltage. If the controller receives the positive-phase feedback voltage, an inverting unit should be adopted to convert the positive-phase feedback voltage into an inverting feedback voltage and generate the switch-driving signal according to the inverting feedback voltage; if the controller receives the inverting feedback voltage, the controller can directly generate the switch-driving signal according to the inverting feedback voltage.

The step S14 is to decrease the opto-coupling currents and increase the feedback voltage when the output power of the isolated power converter becomes smaller. The step S16 is to use the controller to reduce the duty cycle of the switch-driving signal according to the feedback voltage having a higher level.

Compared with the prior arts, when the output power of the isolated power converter becomes smaller, the invention can lower down the currents flowing through the optocoupler to reduce its energy consumption. In addition, because the energy consumption is reduced, the total energy that the isolated power converter should provide is also reduced. And in the meantime, the operating consumption of the isolated power converter, such as switching loss, conduction loss, and transformer loss, can all be reduced as well. Therefore, the invention can enhance the light-load efficiency of the isolated power converter and reduce the standby power consumption of the isolated power converter.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An isolated power converter, comprising:
a transformer;
an inverting type shunt regulator, located on the secondary side of the transformer, the inverting type shunt regulator comprising an error amplifier and a MOSFET (Metal-Oxide-Semiconductor Field-Effect Transistor);
a controller, located at on the primary side of the transformer, the controller comprising an inverting unit cooperated with the MOSFET, the controller receiving a feedback voltage; and
an optocoupler, coupled to the inverting type shunt regulator and the controller, for providing an opto-coupling current to the controller.

2. The isolated power converter of claim 1, wherein the MOSFET is a p-type MOSFET or an n-type MOSFET.

3. The isolated power converter of claim 1, wherein the controller further comprises a pulse-width modulator, if the feedback voltage received by the controller is a positive-phase feedback voltage, the inverting unit converts the positive-phase feedback voltage into an inverting feedback voltage and the pulse-width modulator generates a switch-driving signal according to the inverting feedback voltage.

4. The isolated power converter of claim 1, wherein the controller further comprises an inverting type pulse-width modulator, if the feedback voltage received by the controller is a positive-phase feedback voltage, the inverting type pulse-width modulator converts the positive phase feedback voltage into an inverting feedback voltage and generates a switch-driving signal according to the inverting feedback voltage.

5. The isolated power converter of claim 1, wherein the controller further comprises a pulse-width modulator, if the feedback voltage received by the controller is an inverting feedback voltage, the pulse-width modulator generates a switch-driving signal according to the inverting feedback voltage.

6. The isolated power converter of claim 1, wherein the inverting type shunt regulator further comprises a first terminal, a second terminal, a third terminal, and a fourth terminal, the first terminal is coupled to an external reference voltage, the third terminal is coupled to the optocoupler, the fourth terminal is coupled to a ground terminal, a compensating circuit is coupled between the first terminal and the third terminal, the MOSFET is coupled between the second terminal and the third terminal.

7. The isolated power converter of claim 1, wherein the inverting type shunt regulator further comprises a first terminal, a second terminal, a third terminal, and a fourth terminal, the first terminal is coupled to an external reference voltage, the third terminal is coupled to the optocoupler, the third terminal is coupled to a ground terminal, the fourth terminal is coupled between the error amplifier and the MOSFET, one terminal of a compensating circuit is coupled to the first terminal, and the other terminal of the compensating circuit is coupled to the fourth terminal, the MOSFET is coupled between the second terminal and the third terminal.

8. The isolated power converter of claim 1, wherein the controller is a pulse-width modulation controller, the optocoupler is coupled to the pulse-width modulation controller and a ground terminal, the optocoupler provides a positive-phase feedback voltage to the pulse-width modulation controller.

9. The isolated power converter of claim 1, wherein the controller is a pulse-width modulation controller, the pulse-width modulation controller is coupled to a supply voltage, the optocoupler is coupled to the supply voltage and the pulse-width modulation controller, the optocoupler provides an inverting feedback voltage to the pulse-width modulation controller.

10. An inverting type shunt regulator, applied in an isolated power converter comprising a transformer and a controller, the controller being located on the primary side of the transformer and comprising an inverting unit, the inverting type shunt regulator being located on the secondary side of the transformer and cooperated with the inverting unit, the inverting type shunt regulator comprising:
a first terminal, coupled to an external reference voltage;
a second terminal;
a third terminal;
an error amplifier having a first input terminal, a second input terminal, and an output terminal, wherein the first input terminal is coupled to the first terminal and the second input terminal is coupled to an internal reference voltage; and
a MOSFET, coupled between the second terminal and the third terminal, wherein a gate electrode of the MOSFET is coupled to the output terminal of the error amplifier.

11. The inverting type shunt regulator of claim 10, wherein the MOSFET is a p-type MOSFET or an n-type MOSFET.

12. The inverting type shunt regulator of claim 10, wherein the isolated power converter further comprises a first dividing resistor and a second dividing resistor, the first dividing resistor is coupled to the output voltage and the second dividing resistor is coupled between the first dividing resistor and a ground terminal, the first terminal is coupled to the external reference voltage between the first dividing resistor and the second dividing resistor.

13. The inverting type shunt regulator of claim 10, wherein a compensating circuit is coupled between the first terminal and the third terminal.

14. The inverting type shunt regulator of claim 10, wherein one terminal of a compensating circuit is coupled to the first terminal and the other terminal of the compensating circuit is coupled between the error amplifier and the MOSFET.

15. An operating method for an isolated power converter, the isolated power converter comprising a transformer, an inverting type shunt regulator, a controller, and an optocoupler, the controller being located on the primary side of the transformer and comprising an inverting unit, the inverting type shunt regulator being located on the secondary side of the transformer and comprising an error amplifier and a MOSFET, the inverting unit being cooperated with the MOSFET, the operating method comprising following steps of:
(a) using the inverting type shunt regulator to control an opto-coupling current provided for the controller by the optocoupler;
(b) using the controller to receive a feedback voltage which is determined according to the opto-coupling current and generate a switch-driving signal according to the feedback voltage;
(c) decreasing the opto-coupling currents and increasing the feedback voltage when the output power of the isolated power converter becomes smaller; and
(d) using the controller to reduce the duty cycle of the switch-driving signal according to the feedback voltage having a higher level.

16. The operating method of claim 15, wherein in the step (b), if the feedback voltage received by the controller is a positive-phase feedback voltage, the inverting unit will convert the positive-phase feedback voltage into an inverting feedback voltage and the controller will generate the switch-driving signal according to the inverting feedback voltage.

17. The operating method of claim 15, wherein in the step (b), if the feedback voltage received by the controller is an inverting feedback voltage, the controller will generate the switch-driving signal according to the inverting feedback voltage.
